(19) United States
(12) Patent Application Publication
(10) Pub. No.: US 2022/0000292 A1
(43) Pub. Date: Jan. 6, 2022

(54) GLASS BOTTLE HAVING AN INSERTED BOTTOM

(71) Applicant: Uwe Ehinger, Hamburg (DE)

(72) Inventor: Uwe Ehinger, Hamburg (DE)

(21) Appl. No.: 17/290,142

(22) PCT Filed: Oct. 30, 2019
(86) PCT No.: PCT/EP2019/079597

§ 371 Date: Apr. 29, 2021

(30) Foreign Application Priority Data
Oct. 30, 2018 (EP) 18203550.1

(51) Int. Cl. A47G 19/22; B65D 8/00

(52) U.S. Cl. CPC A47G 19/2205; B65D 2203/00; B65D 15/02

(57) ABSTRACT

The invention relates to a glass bottle (1) having an inserted hard bottom and a three-dimensional decorative element (4) in the bottle interior, the glass bottle comprising a glass hollow body (2) having the shape of a bottle, a bottom insert (3) and a three-dimensional decorative element (4) in the interior of the glass bottle. The invention further relates to a method for producing a bottle having an inserted hard bottom. In the case of the bottle according to the invention, it is possible to combine glass with another material and to nevertheless obtain a sealed bottle. The bottle is closed liquid-tight, even though the bottom consists of a separate component. Any objects can be inserted into the bottle interior for decoration.

The object of the invention is a glass bottle with an inserted hard bottom and a three-dimensional decorative element in the bottle interior comprising a glass hollow body in the shape of a bottle, a bottom insert and a three-dimensional decorative element in the interior of the glass bottle. The object of the invention furthermore comprises a manufacturing method for a bottle with an inserted hard bottom.

Bottles are a popular storage vessel, especially for liquids. They are used for beverages, such as water, milk, wine, juice or alcoholic beverages, as well as for oils or for cosmetic or medicinal liquids. Glass is a material which is commonly used to produce bottles, since it is food-safe and inert, can be easily shaped and is comparatively inexpensive. Glass is also a popular material for use in bottles from an environmental viewpoint.

For advertising purposes, but also for optical reasons, glass bottles are often decorated. This is done, for example, by means of labels, embossing on the bottle, engraving or the attachment of objects to the bottle.

A glass bottle with a decorative object arranged inside the bottle is known from DE 10 2006 01 1 282 A1. To insert the object, the bottle bottom is separated from the body of the bottle and a new functional bottom made of glass, to which the decorative object is attached, is inserted. Thus, a closed glass bottle with a glass bottom is re-created. Accordingly, only glass objects that are fused with the glass bottom can be inserted into the bottle.

This invention is aimed at providing a glass bottle which overcomes the aforementioned disadvantages, into which any decorative elements can be inserted and which permits the storage of foodstuffs. Furthermore, this invention is aimed at providing a manufacturing method for such a glass bottle.

The aim is achieved according to the invention by a glass bottle as per patent claim 1 and a manufacturing method as per patent claim 11.

Other embodiments are the subject of the subclaims or described below.

The glass bottle according to the invention has an inserted hard bottom, the bottom insert, and a three-dimensional decorative element in the bottle interior, i.e., the space inside the bottle. The glass bottle according to the invention features:
a glass hollow body which is in the shape of a bottle,
if necessary, sealing elements which can also be molded onto the bottom to insert,
a bottom insert, and
a three-dimensional decorative element in the interior of the glass bottle.

The glass hollow body has an opening, in the bottom, with the opening being centered/concentric, for example, in the case of a round bottle bottom. In one embodiment, the opening is a circular opening. The bottom insert corresponds in size and shape to the opening in the bottom of the glass hollow body and closes the opening in the glass hollow body through friction locking and/or material locking. The friction-locking closure is preferably achieved with a clamp or screw connection or flare joint. The material-locking closure is preferably achieved with an adhesive connection. A combination of a material-locking adhesive connection and a friction-locking clamping connection, e.g., with a sealing ring or flare joint, should preferably be used. In both, an additional seal is preferably used to ensure food-grade separation between the contents of the bottle and the adhesive joint and to prevent unnecessary stress on the adhesive joint from the liquid in the bottle, such as alcohols or other hydrocarbons. The bottom insert is preferably made of metal or plastic, or a combination of these materials, rather than glass. The bottom insert is used to hold a three-dimensional decorative element, which can be firmly or variably attached to the bottom insert. The mounting fixture, which is directed into the glass bottle, is firmly attached to the bottom insert. A mounting device such as a threaded piece or threaded bore can be used. The three-dimensional decorative element is attached to the mounting fixture and located in the bottle interior.

According to the invention, “underneath” refers to the outside of the bottle bottom, i.e., the area of a bottle located on a surface. “Outside” denotes the outside of the bottle, while inside denotes the inside of the bottle, i.e., the bottle interior.

The bottom insert is preferably in the shape of a flat plate or disc. In this case, it may be made of solid material or, like a lid, it may partially have a negative shape, i.e., a cavity. The bottom insert preferably has a circumferential outer edge which is located in the lower region of the bottom insert and preferably forms a plane with the outside of the bottom insert. In the case of a round bottom insert, the circumferential outer edge is radially circumferential. If the bottom insert has a partial cavity, the cavity is also preferably located on the lower, outward-facing side of the bottom insert on the side opposite the mounting fixture. When installed, the bottom insert may be in a plane with the glass bottom rim or may be shifted up or down so that the glass bottle is either on the glass bottom rim, the glass bottom rim and the bottom insert only, or on the bottom insert only. In one embodiment, the bottom insert has a step-shaped recess on the circumferential outer edge, with the inner step, which is closer to the center of the bottle, being higher than the outer step, and the inner step forms a stop surface for the underside of the glass hollow body. An element such as a hexagon that facilitates the assembly of the three-dimensional decorative element can be fitted to the bottom outside, for example in the cavity.

In one embodiment, the glass bottle according to the invention has at least one sealing element, preferably a radial sealing element, for sealing the bottom insert. In addition to sealing, the sealing element serves to isolate the bottle contents from the adhesive joint so as not to chemically stress the adhesive joint. The sealing element may also serve to decouple the radial guide from vibrations. It ensures that only attenuated relative movements of the insert are possible. The sealing element is, for example, a seal such as an O-ring, preferably made of EPDM or other materials permissible for foodstuffs. In this embodiment, the bottom insert preferably has at least one radial groove in which the sealant is at least partially located.

The three-dimensional decorative element is preferably an artifact, decorative element, souvenir, or figurine. The three-dimensional decorative element is ideally a component of a machine or vehicle, such as a rocker arm or camshaft, or a piece of jewelry, toy or comic figurine. The three-dimensional decorative element is preferably made of a food-grade material, ideally stainless steel, aluminum, brass, precious metals, precious or non-precious stones, or plastic. The three-dimensional decorative element may optionally have a food-grade or passivating coating. The three-dimensional decorative element, like the bottom insert, is preferably not made of glass. The three-dimensional decorative element is preferably one-piece, i.e., it consists of one piece. Alternatively, the three-dimensional decorative element consists of several components, i.e., it has a multi-part structure.

The mounting fixture is preferably attached to the bottom insert firmly, i.e., non-detachably, or variably, i.e., detachably. In one embodiment, the bottom element, the mounting fixture and the three-dimensional decorative element are one-piece, i.e., consist of one piece. This is a variant of the firm, non-detachable attachment. In one embodiment, the three-dimensional decorative element is firmly attached to the mounting fixture. The decorative element and the mounting fixture may also be made in one piece, this is also as understood. The mounting fixture and the decorative element are then formed in one piece.

The connection between the bottom insert and the holding mounting fixture may also be sealed with a sealant, e.g., an O-ring or a liquid sealant such as Loctite®.

A glass bottle is a vessel made of glass with a narrow bottle opening and a base of the neck, a bottle wall or walls and a bottle bottom. The glass bottle according to the invention may have any bottle shape, preferably with a round or rectangular bottom and a cylindrical, conical or cuboid main body terminating in the bottle neck and bottle opening. The glass hollow body is preferably made of transparent, ideally colorless glass, also known as white glass. The glass bottle may be decorated in the customary manner, for example printed, engraved or labeled, although the decoration is not part of the bottle according to the invention.

The glass bottom has an outer region adjacent the walls of the glass bottle and a central region extending around the center of the glass bottom surface. The outer rim of the glass bottle bottom is formed by the glass hollow body, referred to below as the glass bottom rim. The bottom insert is inserted into the opening so that the entire bottle bottom consists of a combination of the bottom insert and the glass bottom rim of the glass hollow body. The glass bottom rim forms the outer area of the bottle bottom, which encloses the bottom insert when installed. The bottom insert forms the middle portion of the bottle bottom, although no portion of the bottom insert is in the area of the glass bottle walls or on the outside of the glass bottle walls. In this embodiment, the glass bottom rim preferably includes a recess on its underside. As defined, the underside of the glass bottom rim is on the outside of the bottle bottom. The recess forms a stop for the bottom insert. This stop is preferably used as an adhesive gap if the bottom insert is bonded to the glass hollow body with adhesive. In an alternative embodiment, the bottom insert forms the entire glass bottle bottom. The opening is then formed by the walls of the glass hollow body rising to the bottle neck.

The glass bottom rim preferably has a step-shaped recess on the underside which forms a stop surface for the bottom insert. The step-shaped recess is located at the edge of the glass bottom rim facing the center of the bottle. In one embodiment, the height of the step corresponds to the height of the circumferential outer edge of the bottom insert. The glass bottle according to the invention has a glass bottom rim facing the center of the bottle on the glass hollow body, and the step-shaped recess is preferably arranged on the underside of the glass bottom rim. The outer edge of the glass bottle bottom and the bottom insert can, for example, form a flat surface and thereby a flat bottle bottom on which the glass bottle stands. The stop surface serves as an area which a surface of the bottom insert strikes, with the two surfaces coming to rest on one another. In one embodiment, an adhesive is applied to the stop surface so that the stop surface simultaneously forms the adhesive surface. In another embodiment, the step-shaped recess has a 2nd step so that the higher step forms the stop surface and the lower step forms the adhesive surface.

The step-shaped recess may be formed as a rectangular step. At its edges on the underside, which face the outside of the bottle, the opening preferably also has a chamfer with partially beveled sides.

The bottom insert is ideally axially attached to the bottom edge of the glass hollow body in a sealing manner using an adhesive connection.

In another embodiment, the glass bottle according to the invention additionally has at least one radial sealant that is attached to the bottom insert, preferably a sealing ring, e.g., an O-ring, a liquid seal or another food-grade sealant. The sealing ring is preferably made of EPDM (ethylene-propylene-diene rubber). Alternatively, the glass bottle according to the invention additionally has at least one axial sealant, which is less favorable according to the invention.

The bottom insert is preferably made of stainless steel, aluminum, brass, bronze, plastic or a tin-plated metal plate or a combination of these materials. The bottom insert is preferably not made of glass.

The bottle according to the invention may have, for example, any shape which is customary for liquor, wine, juice, oil or beer bottles. The glass bottle according to the invention is preferably a beverage bottle.

The glass bottle according to the invention preferably has a size and volume which is similar to a usual beverage bottle. The glass bottle according to the invention preferably has a volume of 0.5 l, 0.75 l, 1 l, 1.5 l, 2 l, but magnum bottles with 5 l, 6 l, 10 l or 20 l are also possible. The glass bottle according to the invention preferably has a volume of 0.25 l to 20 l, ideally 0.5 l to 20 l or 0.5 to 10 l. The glass bottle according to the invention is suitable for use in machine filling and for industrial scale filling, as well as industrial scale manufacturing.

The glass bottle according to the invention has a common bottle closure. The closure is, for example, a threaded closure, a snap closure, a crown cap, a swing stopper, a stopper, for example, a glass stopper or a cork.

In a preferred embodiment, the bottom insert is bonded to the glass hollow body using a UV adhesive or MS polymer adhesive. A UV adhesive is an adhesive that cures by UV radiation, such as solvent-free, one-component acrylic adhesives that cure by free-radical polymerization, or cationically crosslinking epoxy adhesives. MS polymer adhesives are silane-modified polymer adhesives. The adhesive connection prevents the bottom insert from slipping out of the bottle. In this embodiment, the sealing of the glass bottle according to the invention is preferably achieved with one or more O-rings. The O-rings are slipped over the outer edge of the bottom insert and, as applicable, come to lie in a groove between the edge of the opening in the bottle bottom and the outer edge of the bottom insert. The advantage in this embodiment is that the glass bottle according to the invention consists of only a few components, namely the glass hollow body, the bottom insert with attached mounting fixture and the decorative element, as well as optionally at least one O-ring for sealing. Sealing with a sealing ring means that only an attenuated relative movement of the bottom insert is possible from then on.

In one embodiment, a receptacle for a form-fitting tool, preferably a hexagon, is provided in a bulge on the underside of the bottom insert. The receptacle for a form-fitting tool serves to better guide a tool, such as an open-end wrench or hexagon socket wrench, and enables better screwing between the bottom insert and the mounting fixture. The mounting fixture in this case is, for example, a screw thread on the underside of the three-dimensional decorative element and a threaded receiving opening inside the mounting fixture for the form-fitting tool.

Surprisingly, in the bottle according to the invention, it is possible to combine glass with another material and still obtain a sealed bottle. The bottle is sealed liquid-tight even though the bottom is made of a separate component. Once the bottom has been sealed, the glass bottle according to the invention can be filled using a normal filling system.

The bottom insert of the bottle according to the invention has a dual function. Unlike conventional bottles, the bottom insert does not serve only as a seal. Rather, the bottom insert also holds the three-dimensional decorative element inserted in the bottle. The bottom insert thus has the dual function of sealing and holding.

### Method

This invention is furthermore aimed at providing a manufacturing method for a glass bottle with a bottom insert, with the glass bottle comprising a glass hollow body with the shape of a bottle, a bottom insert, and a three-dimensional decorative element in the interior of the glass bottle, and the glass hollow body has an opening, preferably a circular opening, in the bottom, with the opening being preferably centered/concentric in the case of a round bottle bottom,
the bottom insert is at most the same size as the opening in the bottom of the glass hollow body, preferably slightly smaller than the opening in the bottom of the glass hollow body,
the bottom insert closes the opening in the glass hollow body in a friction-locking and/or material-locking manner,
the bottom insert is made of metal or plastic, not glass,
a mounting fixture is attached to the bottom insert on the upper side of the bottom insert facing the bottle and directed into the glass bottle, and
the three-dimensional decorative element is attached to the mounting fixture and is located in the bottle interior.

The method according to the invention comprises the following steps:
blowing a glass bottle in a hollow mold and reaming the bottom of the cooled glass bottle to produce a glass hollow body, or
pressing a glass hollow body in a press mold, and after producing the glass hollow body by blowing or pressing:
grinding the edges of the opening in the bottom to create an adhesive surface, preferably making a step-shaped recess at the edge of the bottom, preferably grinding the bottom without grinding the outer adhesive surface,
applying an adhesive to the adhesive surface on the glass hollow body or to a surface of the bottom insert,
providing a bottom insert with mounting fixture and a decorative three-dimensional element, with the decorative three-dimensional element being attached to the bottom insert by the mounting fixture, and
inserting the bottom insert with a decorative three-dimensional element into the opening in the bottom of the glass hollow body and closing the glass bottle using the bottom insert.

In one embodiment, a UV adhesive or MS polymer adhesive is applied to the adhesive surface on the glass hollow body or the bottom insert before the bottom insert is put in place. If a UV adhesive is used, the adhesive surface is additionally irradiated after the bottom insert is inserted into the glass bottle.

Providing a bottom insert preferably comprises the following steps:
providing a bottom insert with a mounting fixture firmly attached to the bottom insert,
providing a three-dimensional decorative element,
attaching the three-dimensional decorative element to the mounting fixture.

In an alternative embodiment, providing a bottom insert preferably comprises the following steps:
providing a bottom insert,
providing a mounting fixture,
providing a three-dimensional decorative element,
attaching the three-dimensional decorative element to the mounting fixture, and attaching the mounting fixture to the bottom insert.

In one embodiment, the bottom insert additionally has a sealant that is attached to the bottom insert in a further step, preferably after the bottom insert with mounting fixture and three-dimensional decorative element has been provided.

The method according to the invention is preferably used for manufacturing the bottle according to the invention.

The invention is explained in more detail using the figures. It shows

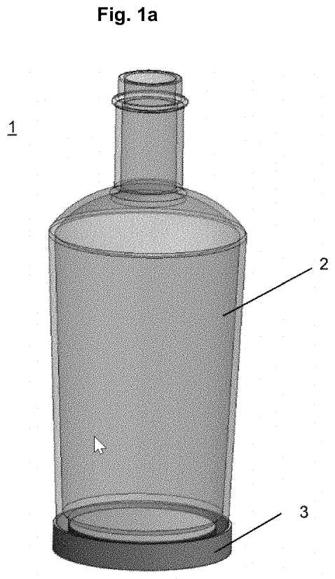

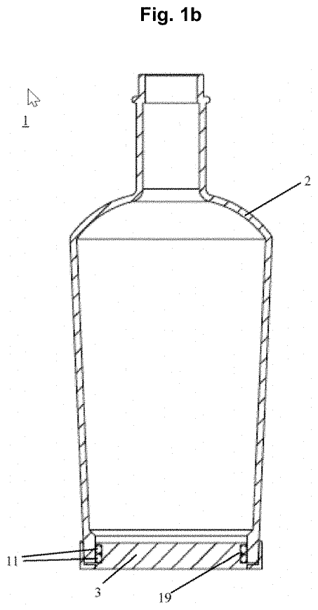

FIG. 1 a glass bottle without decorative element perspective view and in longitudinal section,

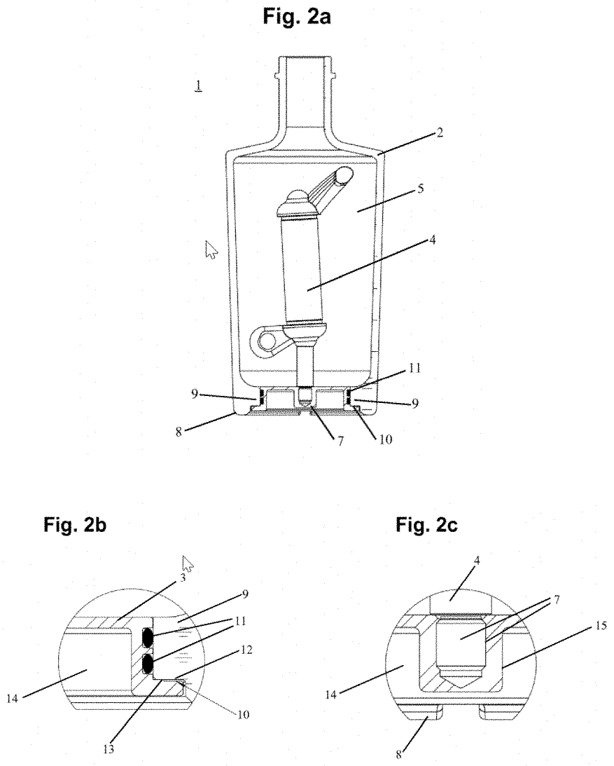

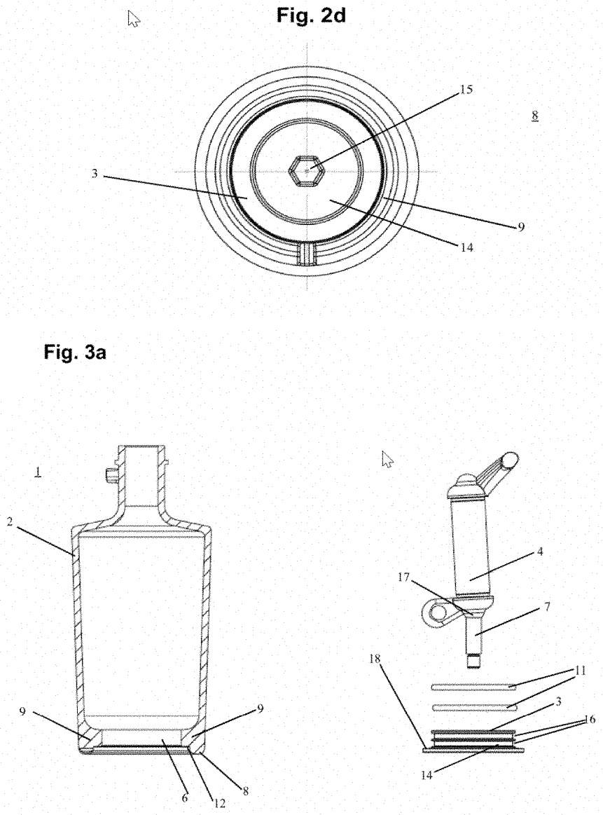

FIG. 2 an embodiment of a glass bottle according to the invention in longitudinal section, and

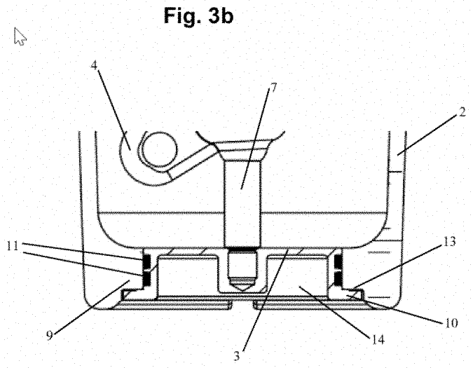

FIG. 3 another embodiment of a glass bottle according to the invention before assembly.

FIG. 1a shows a glass bottle 1 without inserted decorative element in a perspective view. The glass bottle 1 has a glass hollow body 2 and a bottom insert 3. The bottom insert 3 is designed in 2 parts, with the inner part engaging in the glass hollow body and the outer part being positioned as a ring around the glass bottom. FIG. 1b shows a longitudinal section through the glass bottle 1 from FIG. 1a. The bottom insert 3 has 2 radial grooves 16, with one sealing ring 11 located in each. The lower outer edge of the glass hollow body 2 is ground so that a step-shaped recess 12 is formed on the outside of the glass hollow body. Adhesive is applied to the vertical surface of the step-shaped recess 12 so that the vertical surface forms a radial adhesive surface 19.

FIG. 2a shows a longitudinal section through an embodiment of a glass bottle 1 according to the invention. The glass bottle 1 has a glass hollow body 2 with an opening 6 in the bottle bottom 8. The bottle bottom has a bottom rim 9 which surrounds the opening in a circular manner. The opening 6 is closed by the bottom insert 3. The bottom insert 3 is designed as a disc and has an outer circumferential edge 10. The bottom insert 3 is surrounded by a sealing ring 11 which seals the gap between the bottom insert and the glass hollow body in the opening. The bottom insert 3 has a mounting fixture 7, which is designed here as a thread. A three-dimensional decorative element 4, which is a rocker arm here, is attached to the mounting fixture. The rocker arm has a thread at its lower end, with which it is screwed to the mounting fixture. It can be seen that the rocker arm is located in the interior 5 of the glass bottle.

FIG. 2b shows an enlarged section of a portion of the bottle bottom 8. It can be seen that the glass bottom rim 9 has a step-shaped recess 12 on its underside. The horizontal surface of the step forms a supporting surface 13, to which adhesive can be applied. The outer circumferential edge 10 of the bottom insert 3 rests with its upper side 18 against the stop surface 13. The bottom insert 3 also has a step-shaped recess. The higher step of the bottom insert rests against the stop surface 13, and a small cavity can be seen between the lower step of the step-shaped recess and glass bottom rim 9, which is filled by the adhesive when the two elements are brought together. The two surfaces are attached using adhesive so that axial bonding occurs. In this embodiment, the bottom insert 3 has 2 radial grooves 16, which serve to receive the sealant 11, which are designed as an O-ring here.

FIG. 2c shows another enlarged section of another part of the bottle bottom 8. The bottom insert 3 is formed as a disc with a cavity 14 here. The center of the bottom insert 3 comprises a hexagon 15 which has an internal thread in its interior. The lower end of the three-dimensional decorative element 4 has an external thread which is screwed into the internal thread inside the hexagon 15.

FIG. 2d shows a top view of the bottle bottom 8 of the glass bottle from FIG. 2a. The outer edge of the bottle bottom 8 is formed by part of the glass hollow body in the form of the glass bottom rim 9. The bottom insert 3 is inserted into the glass bottle. Hexagon 15 can be seen in the center of the bottom insert 3. There is a cavity 14 between the outer circumferential edge 10 of the bottom insert and the hexagon 15.

FIG. 3a shows a further embodiment of a glass bottle 1 according to the invention in longitudinal section. The individual components of the glass bottle are not yet attached to each other here. The left-hand side shows the glass hollow body 2, which has an opening 6 bottle bottom 8. The glass hollow body 2 forms a glass bottom rim 9, which is part of the bottle bottom 8. The underside of the glass bottom rim 9 has a step-shaped recess 12. The right-hand side shows bottom insert 3 with mounting fixture 7 firmly mounted on it. The bottom insert 3 and the mounting fixture 7 are made in one piece here. The underside of bottom insert 3 has an outer circumferential edge 10. The bottom insert is hollowed out on its underside and has a cavity 14. On its vertical side wall, the bottom insert 2 has outer radial grooves 16 which serve to mount a sealing ring 11. A three-dimensional decorative element 4 is shown above the bottom insert 3. This has a bore 17 on its underside with which it is attached to the mounting fixture 7.

FIG. 3b shows a section of the lower area of the glass bottle from FIG. 3a after assembly. It can be seen that the bottom insert 3 closes the opening 6 in the glass hollow body 2. The sealing rings 11 are thereby clamped between the edge of the bottom insert and the edge of the opening 6, thus sealing the bottom. The supporting surface 13 rests on the outer circumferential edge 10 of the bottom insert, with the two being attached to each other using adhesive.

### Key

glass bottle 1

glass hollow body 2

bottom insert 3

three-dimensional decorative element 4

interior 5

opening 6

mounting fixture 7

bottle bottom 8

glass bottom rim 9

outer circumferential edge 10

sealing ring 11

step-shaped recess 12

stop surface 13

cavity 14

hexagon 15

groove 16

bore 17

bottom insert upper side 18

radial adhesive surface 19

1. A glass bottle comprising
a glass hollow body in a shape of a bottle
a rigid bottom insert, and
a three-dimensional decorative element in an interior portion of the glass bottle,
wherein
the glass hollow body has an opening in a bottom portion of the glass hollow body,
the rigid bottom insert corresponds in size and shape to that of the opening in the bottom portion of the glass hollow body,
the rigid bottom insert closes the opening in the glass hollow body in a friction-locking or form-fitting manner,
a mounting fixture is attached to the rigid bottom insert on an upper side of the bottom insert facing the bottle and is directed into the glass bottle,
the three-dimensional decorative element is attached to the mounting fixture and is located in the interior portion of the glass bottle, and
a glass bottom rim is formed by the bottom portion of the glass hollow body.

2. The glass bottle according to claim 1, wherein the glass bottom rim has a step-shaped recess on an underside of the glass bottom rim, and wherein the step-shaped recess forms a stop surface for the rigid bottom insert.

3. The glass bottle according to claim 1, wherein the rigid bottom insert is attached radially or axially to the glass hollow body via an adhesive connection.

4. The glass bottle according to claim 1, wherein the rigid bottom insert is made of metal or plastic.

5. The glass bottle according to claim 1, wherein the mounting fixture is firmly attached to the rigid bottom insert.

6. The glass bottle according to claim 1, wherein the rigid bottom insert has a radially circumferential outer edge which is located in a lower region of the rigid bottom insert and forms a plane with an outside of the rigid bottom insert, and wherein the radially circumferential outer edge of the rigid bottom insert is axially attached to the glass bottom rim of the glass hollow body by means of an adhesive connection.

7. The glass bottle according to claim 1, wherein the rigid bottom insert has a step-shaped recess, with an inner step being higher than an outer step and the inner step forming a stop surface for an underside of the glass hollow body.

8. The glass bottle according to claim 1, wherein the glass bottle has at least one radial sealant that is attached to the rigid bottom insert, and wherein the at least one radial sealant includes an O-ring or other food-grade sealant.

9. The glass bottle according to claim 1, wherein the rigid bottom insert is made of stainless steel, aluminum, brass, bronze, plastic, a tin-plated metal plate or a combination of these materials.

10. The glass bottle according to claim 1, wherein the rigid bottom insert has a cavity at least partially on an underside of the rigid bottom insert, and wherein the rigid bottom insert optionally has a receptacle for a form-fitting tool on the underside of the rigid bottom insert, and wherein the mounting fixture is screwed into the receptacle.

11. The glass bottle according to claim 1, wherein the glass bottle consists of the glass hollow body, the rigid bottom insert, the mounting fixture, the three-dimensional decorative element, a bottle cap and optionally one or more sealants.

12. A manufacturing method for a glass bottle with a rigid bottom insert, with the glass bottle comprising a glass hollow body with a shape of a bottle, the rigid bottom insert, and a three-dimensional decorative element in an interior of the glass bottle, and the glass hollow body has an opening in a bottom portion, the method comprising the following steps:
Blowing the glass bottle in a hollow mold,
cooling the glass bottle, and
reaming the bottom portion of the cooled glass bottle to produce the glass hollow body; or
Pressing the glass hollow body in a press mold,
producing the glass hollow body by blowing or pressing,
grinding of edges in the opening in the bottom portion to produce an adhesive surface
applying an adhesive to the adhesive surface or to a surface of the rigid bottom insert,
providing the rigid bottom insert with a mounting fixture and the decorative three-dimensional element, with the decorative three-dimensional element being attached to the rigid bottom insert via the mounting fixture, and
inserting the rigid bottom insert with the decorative three-dimensional element into the opening in the bottom portion of the glass hollow body and closing the glass bottle with the rigid bottom insert.

13. The method according to claim 12, wherein a UV adhesive or MS polymer adhesive is applied to the adhesive surface on the glass hollow body before the rigid bottom insert is inserted and wherein the adhesive surface is optionally irradiated to cure the UV adhesive after insertion of the rigid bottom insert.

14. The method according to claim 12, wherein the step of providing the rigid bottom insert comprises the following steps:
providing the rigid bottom insert,
providing the mounting fixture,
providing the three-dimensional decorative element,
attaching the three-dimensional decorative element to the mounting fixture, and attaching the mounting fixture to the rigid bottom insert.

15. The method according to claim 12, wherein the step of providing the rigid bottom insert comprises the following steps
providing the rigid bottom insert with the mounting fixture,
providing the three-dimensional decorative element,
attaching the three-dimensional decorative element to the mounting fixture.

16. The method according to claim 13, wherein the rigid bottom insert additionally comprises at least one sealant and in a further step the sealant is fixed to the rigid bottom insert.

17. (canceled)

18. The glass bottle according to claim 1, wherein the mounting fixture is variably attached to the rigid bottom insert.
